(19) United States
(12) Patent Application Publication
(10) Pub. No.: US 2024/0375880 A1
(43) Pub. Date: Nov. 14, 2024

(54) Conveyor Device

(71) Applicant: Interroll Holding AG, Sant' Antonino (CH)

(72) Inventors: Stephan Kronholz, Hückelhoven (DE); Christian Ripperda, Hückelhoven (DE); Kai Lubomierski, Hückelhoven (DE)

(21) Appl. No.: 18/690,730

(22) PCT Filed: Sep. 26, 2022
(86) PCT No.: PCT/EP2022/076677

§ 371 Date: Mar. 10, 2024

(30) Foreign Application Priority Data
Oct. 7, 2021 (DE) 10 2021 126 045.0

(51) Int. Cl. B65G 17/36; A22C 21/00; A22C 25/08; B65G 47/61

(52) U.S. Cl. CPC B65G 17/36; A22C 21/0053; A22C 25/08; B65G 47/61; B65G 2201/0202

(57) ABSTRACT

Conveyor device (1), adapted
to take over a conveyed good (F2), in particular a piece of meat, at a takeover area (A1) from an upstream feeding device (110),
to handover the conveyed good (F2) at a handover area (A3), in particular to a downstream discharge device (120),
to transfer the conveyed good (F2) in a transfer area (A2) from the takeover area (A1) to the handover area (A3),
   wherein the conveyor device (1) comprises a plurality of discrete transport units (21), in particular transport baskets (21),
   the transport units (21) being arranged in particular in a circulating manner, characterized in
   that the transport units (21) are adapted
to take over the conveyed good (F2) at the takeover area (A1), in particular to catch a conveyed good provided by a meat dismantling device (112) in the vertically falling state,
to be transferred between the takeover area (A1) and the handover area (A3),
and to handover the conveyed good (F2) at the handover area (A3).

### CROSS REFERENCE TO RELATED APPLICATIONS

This application is the U.S. national stage of International Application No. PCT/EP2022/076677, filed on 2022 Sep. 26. The international application claims the priority of DE 102021126045.0 filed on 2021 Oct. 7; all applications are incorporated by reference herein in their entirety.

### BACKGROUND

The invention relates to a conveyor device.

Hygiene plays a very important role in particular in the food industry. It is unavoidable that food comes into contact with microbiological germs. However, the extent of the contamination has a significant effect on the shelf life of the food.

Therefore, the equipment involved in food processing is constantly cleaned. Cleaning must take place at defined intervals, which are determined depending on the respective contamination or contamination with biological germs. In other words, in the case of an increased contamination load, cleaning is carried out more frequently than in the case of a lower contamination load. For a deep cleaning of the plants, parts of the production have to be shut down.

In particular in the meat processing industry, meat is often cut in order to separate individual pieces of meat from a carcass. In highly optimized processes, cutting operations take place very quickly, so that the proverbial “sparks fly”. These sparks now fly uncontrolled through the air and, in addition to the good parts, increase contamination on contact surfaces for processing and transporting the food parts. This increased contamination, in turn, leads to increased cleaning needs and efforts. In the context of the present description, meat is expressly understood to include fish meat as well as poultry meat.

In particular, the catching of meat parts after a meat dismantling device has so far been carried out by means of stainless steel plates along which the meat parts slide. Each piece of meat sliding along contaminates the stainless steel sheet along the slide; the contaminated sheet in turn contaminates each subsequent piece of meat with the microbiological germs of the previous pieces of meat. Thus, the contaminations multiply. Such an arrangement is disclosed in WO 2020/164759 A1.

The as yet unpublished German patent application 10 2020 134 233.0 describes a conveyor device, in particular for meat parts, which can be arranged downstream of a dismantling device. A plurality of discrete transport units are provided for transporting the meat parts. The conveyor device is set up in such a way that it can catch the meat pieces falling vertically and in a localized scattering. For this purpose, a plurality of transport units are positioned in a takeover area in such a way that they together form an enlarged catching surface. The pieces of meat are thus caught by any one of the multiple transport units in the takeover area.

US 2010/0221991 A1 discloses a device for skinning of poultry parts. The poultry parts are guided in a targeted manner over a skinning device. It remains open, how the poultry parts get from a dismantling device to this device and are brought into a suitable orientation.

### SUMMARY

Conveyor device (1), adapted
to take over a conveyed good (F2), in particular a piece of meat, at a takeover area (A1) from an upstream feeding device (110),
to handover the conveyed good (F2) at a handover area (A3), in particular to a downstream discharge device (120),
to transfer the conveyed good (F2) in a transfer area (A2) from the takeover area (A1) to the handover area (A3),
   wherein the conveyor device (1) comprises a plurality of discrete transport units (21), in particular transport baskets (21),
   the transport units (21) being arranged in particular in a circulating manner, characterized in
   that the transport units (21) are adapted
to take over the conveyed good (F2) at the takeover area (A1), in particular to catch a conveyed good provided by a meat dismantling device (112) in the vertically falling state,
to be transferred between the takeover area (A1) and the handover area (A3),
and to handover the conveyed good (F2) at the handover area (A3).

### (FIG. 19)

### DETAILED DESCRIPTION

It is the object of the present invention to provide a suitable conveyor device for the food sector, which can be fitted in particular downstream of a meat dismantling device, since contamination by small pieces of meat flying around is particularly high here. The conveyor device should also provide the best possible support for subsequent processing steps.

The object underlying the invention is solved by a conveyor device, a conveying arrangement and a use according to the main claims. Embodiments are subject of the subclaims and the description.

The conveyor device is characterized by a plurality of discrete transport units that can receive the conveyed goods for conveying. The transport units isolated can be comparatively small and therefore provide only a small catching surface for contaminating, undesirable cutting by-products. Undesirable slipping along surfaces is prevented or at least reduced. In particular, the use of walls with recesses reduces the contact surfaces.

In one embodiment of the invention, the conveyor device performs a defined takeover and/or handover of the conveyed goods. In particular, the defined takeover and/or handover comprises the following aspects:

Aspect “takeover or handover in a predefined orientation”. This means that the conveyor device takes over or hands over the conveyed goods in such a way that similar areas of the transported conveyed goods always point in the same direction. In the example embodiment, this is illustrated in such a way that a bone of a leg of chicken in the conveyor device—starting from the upper leg—always points downwards when it is picked up by the conveyor device and always points to the left after handover at the handover area. If downstream processing stations can rely on the conveyed goods being provided in a defined orientation, automated processing can be carried out there with little effort but high robustness. The complexity of sensors can be reduced and downstream mechanical or manual alignment can be omitted.

Aspect “takeover or handover in a predefined sequence”. The sequence in which the conveyed good is delivered to the handover area is predetermined. In particular, it is ensured that the conveyed good is transferred to the handover area in the sequence in which it is taken over at the takeover area and/or fed by the feeding device. Although it is basically possible in the conveyor devices mentioned at the beginning that a predetermined sequence is maintained, it is by no means guaranteed; for example, conveyed goods can always be expected to “get stuck” on stainless steel chutes; at the takeover area of the device according to DE 10 2020 134 233.0, conveyed goods can be overtaken at the catching area, depending on which transport unit from the large number of transport units at the takeover area the conveyed good falls into. Due to the high random probability, it is not possible to speak of a predefined sequence with the aforementioned prior art devices. It is advantageous if the conveyed goods are taken over by the transport units in a directly predefined sequence.

The known sequence can now be used to assign data to a specific conveyed good, even if the individual conveyed good cannot be identified. Unpackaged food items in particular are not equipped with identifiers. The defined sequence allows a conveyed good to be sent to a downstream processing station based on data that was assigned to the conveyed goods in their original sequence (before the conveyor device). For example, an object unit (e.g. poultry carcass) is assigned data on origin, rearing type (e.g. battery rearing, organic), size/weight and/or damage before the dismantling process. This data can now be abstractly assigned to an item in the original sequence of the object units. If the sequence of the transferred product parts after the conveyor device is identical to the original sequence, the data can be assigned to the object parts and used at subsequent processing stations.

Aspect “takeover or handover in a predefined cycle”. It is advantageous if the conveyed good is transferred in a predefined cycle. The predefined cycle can result in constant delivery intervals (time interval) at the handover area and/or in constant spatial intervals between the conveyed goods at the discharge device. Subsequent processing stations can benefit from this, as the arrival of reliably separated conveyed goods at a predefined interval can reduce effort and/or increase reliability.

In particular, the object parts are provided by the feeding device and/or by the dismantling device in a vertically falling state.

The conveyor device is used in particular for conveying similar conveyed goods.

In particular, the transport units are geometrically adapted to the type of conveyed good to be transported, especially for the purpose of self-alignment in order to take over the conveyed good in a predefined orientation by the transport unit.

The multiplication of the contaminations described at the beginning can at least be reduced by the invention. Any reduction of the multiplication in turn allows an extension of the shelf life and/or an increase of the cleaning intervals.

In one embodiment, the conveyor device is a food conveyor device, in particular a meat conveyor device. In particular, the conveyed good is a food item, in particular a meat item, in particular a poultry item.

In particular, the conveyed good is unpacked.

In particular, the conveyed good is provided without an identifier. In particular, unpackaged food of the same type, especially meat parts, cannot be reliably identified.

In one embodiment, the takeover area, viewed from above, has a takeover area with a first surface area, and the handover area, viewed from above, has a handover area with a second surface area, wherein the first surface area is greater than, in particular at least twice as large as, the second surface area.

In one embodiment, the transport units are mounted in such a way that they can be individually transferred between a receiving position and a handover position. In the receiving position, the conveyed good is held in the respective transport unit in a manner secured against falling out. In the handover position, the conveyed good falls out of the respective transport unit due to gravity. In particular, the transport unit can be pivoted between the receiving position and the handover position.

In one embodiment, a control arrangement is provided which is set up to transfer the transport unit between the receiving position and the handover position, in particular depending on its position. In particular, the transport unit is transferred to the handover position when the transport basket reaches the handover area and/or the transport units are transferred at the latest before reaching the takeover area.

In one embodiment, the control arrangement comprises a control rail, which is arranged in sections in a defined orientation relative to the transport units that can be moved in a conveying direction. In particular, the defined orientation of the control rail in sections determines the position, in particular the handover position or the receiving position, of the transport unit in the associated section.

In one embodiment, the sectionally defined alignment of the control rail, in particular the alignment of a displaceable control rail segment of the control rail, can be adjusted by an actuator.

In one embodiment, the transport units each provide an individual catching surface when viewed from above, wherein a number of transport units are arranged relative to one another in the takeover area in such a way that they form a closed overall catching surface which is larger than the individual catching surface. The total catching area can be at least twice, preferably at least three or four times, the individual catching area and/or the total catching area can be larger than the individual catching area multiplied by the number.

In one embodiment, the transport unit has a triangular shape when viewed from above. Alternatively or in combination, several transport units arranged next to each other form a circular sector shape. The above applies in particular if the transport units are arranged in the takeover area.

In one embodiment, the transport unit has a wall comprising a plurality of recesses. The recesses make up at least 30% of the wall and/or the transport unit has a downwardly tapering collar at the top, whereby the collar increases the size of an individual catching surface formed by the transport unit compared to a receiving space.

In one embodiment, a support rail is provided which is designed to support the transport unit between the takeover area and the handover area. In particular, the support rail has a three-dimensionally curved course and/or the support rail has at least one ascending section and one descending section. The support rail can have a circular cross-section.

In one embodiment, the transport unit is attached to a transport carriage that can be moved along a support rail. In particular, the transport carriage has a C-shaped form when viewed in the transport direction.

In one embodiment, the support rail can be moved at least in sections between an operating position and a maintenance position, whereby in the operating position the support rail is arranged in such a way that the transport units can takeover the conveyed goods at the takeover area, and in the maintenance position the support rail is displaced in such a way that the support rail is removed from the takeover area.

In one embodiment, the support rail is attached to a base support with two base support parts, whereby the support rail is attached to a second support part and a first base support part is held stationary in particular. The second base support part is mounted so that it can be displaced, in particular pivoted, relative to the first base support part. In particular, the second base support part can be fixed relative to the first base support part by means of a fixing means. In particular, by allowing the second base support carrier part to be displaced relative to the first base support part, a holding arrangement can release the conveyor device from an area below a delivery unit of a feeding device.

In one embodiment, a wiper is provided which is designed to travel along the support rail and which is designed to at least partially remove soiling from the support rail. The wiper can have a rubber lip that is in sliding contact with the mounting rail. The wiper can be moved along the support rail together on a transport carriage and/or a transport unit.

In one embodiment, the transport units and/or the transport carriages, in particular two transport units and/or transport carriages adjacent in the conveying direction, are at least indirectly drive-connected to one another via a traction means. The traction means can be an elastic cable and/or this is drive-connected to the transport units and/or the transport carriages at intervals, in particular at regular intervals.

In one embodiment, the traction means is connected in an articulated manner to the respective transport unit and/or the respective transport carriage, in particular by means of an articulation. The connection can be such that an alignment of the traction means relative to the respective transport unit and/or the respective transport carriage can be adapted depending on the relative alignment of two adjacent transport units and/or transport carriages to each other.

In one embodiment, the conveying direction has a curved course in a curved section, with the traction means being arranged within a common traction means plane within the curved section.

The common traction means plane can be aligned with a rail plane defined by a center axis of the support rail in the curve section.

In an alternative embodiment, a support wheel is provided in the traction means plane or parallel to the common traction means plane, which is set up to radially support the traction means, the transport carriage and/or the transport unit. Optionally, the traction means, the transport carriage and/or the transport unit can be guided in the curve section on a circumferential surface of the support wheel.

In one embodiment, the transport units follow a spiral path of movement in sections, whereby the spiral path of movement is only arranged in a straight section of the conveying direction and/or a support rail defining the conveying direction.

In one embodiment, a drive wheel is provided, which is set up for positive drive force transmission to a transport unit and/or a transport carriage via two drive surfaces. A first drive surface is arranged on the drive wheel and a second drive surface is arranged on the transport unit and/or the transport carriage.

The drive connection between the drive motor and the transport unit and/or the transport carriage is preferably form-fit in order to support the synchronization between the conveyor device and the feeding device.

In one embodiment, second drive surfaces of two adjacent transport carriages are provided and/or the transport units have a second circumferential distance from one another at the drive wheel. Two first drive surfaces for driving the transport carriages and/or transport units have a first circumferential distance from one another, with the second circumferential distance being less than the first circumferential distance.

The infeed conveyor can be, in particular, an overhead conveyor.

The transport units are particularly designed to receive product parts with a mass of at least 100 gr, 30 200 gr, 300 gr, 400 gr, 500 gr, 600 gr, 700 gr, 800 gr, 900 gr or 1000 gr and a maximum of 200 gr, 300 gr, 400 gr, 500 gr, 600 gr, 700 gr, 800 gr, 900 gr, 1000 gr, 1200 gr, 1400 gr or 1600 gr of food. The transport units define a receiving space suitable for containing dismantled food products having a volume of at least 1000 cm³, 1500 cm³, 2000 cm³, 2500 cm³, 3000 cm³, 3500 cm³, 4000 cm³, 4500 cm³ or 5000 cm³ and/or a maximum of 1000 cm³, 1500 cm³, 2000 cm³, 2500 cm³, 3000 cm³, 3500 cm³, 4000 cm³, 4500 cm³ or 5000 cm³. In particular, the transport units have a width and/or length and/or height of at least 5 cm, 10 cm, 5, 15 cm, 20 cm, 25 cm, 30 cm, 40 cm or 50 cm and/or a maximum width and/or length and/or height of at least 10 cm, 15 cm, 20 cm, 25 cm, 30 cm, 40 cm or 50 cm.

In particular, the conveyor device according to the invention is set up for catching meat parts that are released from a dismantling device, in particular a meat dismantling machine.

The support rail, the base support, the rail holder and/or other components of the device have, in particular, a stainless steel surface.

### BRIEF DESCRIPTION OF THE DRAWINGS

The invention is explained in more detail below with reference to the figures; herein show:

FIG. 1 a schematically the structure of a conveyor arrangement according to the invention with a conveyor device according to the invention;

FIG. 2 schematically a function of the conveyor device in the context of the conveyor arrangement;

FIG. 3 a transport unit in different views;

FIG. 4 a transport carriage in different views;

FIG. 5 the arrangement of transport carriage and transport unit
a) in a receiving position,
b) in a handover position;

FIG. 6 schematically a section of a conveyor system with several handover areas;

FIG. 7 a section of the conveyor in a top view of the takeover area;

FIG. 8 a schematic comparison of the total catching surface with the individual catching surface

FIG. 9 a section of a support arrangement of the conveyor in side view;

FIG. 10 a section of the support arrangement of the conveyor in perspective view.

FIG. 11 a section of the support arrangement of the conveyor in a further side view;

FIG. 12 a rope attachment in detail in cross-section;

FIG. 13 a section of the takeover area with two transport units as seen from direction of view XIII according to FIG. 7 in one embodiment;

FIG. 14 a section of the takeover area with two transport units as seen from direction of view XIII according to FIG. 7 in another embodiment;

FIG. 15 a section of the takeover area with two transport units as seen from direction of view XV according to FIG. 1 in one embodiment;

FIG. 16 a section of the takeover area according to FIG. 15 as seen from direction XVI according to FIG. 15;

FIG. 17 a section of the return area and the takeover area of the conveyor device of FIG. 1 in perspective view;

FIG. 18 a section of the return area and the takeover area from FIG. 17 in a different perspective;

FIG. 19 schematically the takeover area of the conveyor device and the adjacent areas of the conveyor device and the feeding device;

FIG. 20 schematically the takeover area of the conveyor device according to FIG. 19 in an embodiment;

FIG. 21 schematically the takeover area of the conveyor device according to FIG. 19 in an embodiment;

FIG. 22 schematically the takeover area of the conveyor device according to FIG. 19 in an embodiment;

FIG. 23 schematically the takeover area of the conveyor device according to FIG. 19 in an embodiment;

FIG. 24 gripper of the embodiment according FIG. 23 shown isolated in different gripping situations in top view.

### DETAILED DESCRIPTION OF THE PREFERRED EMBODIMENTS

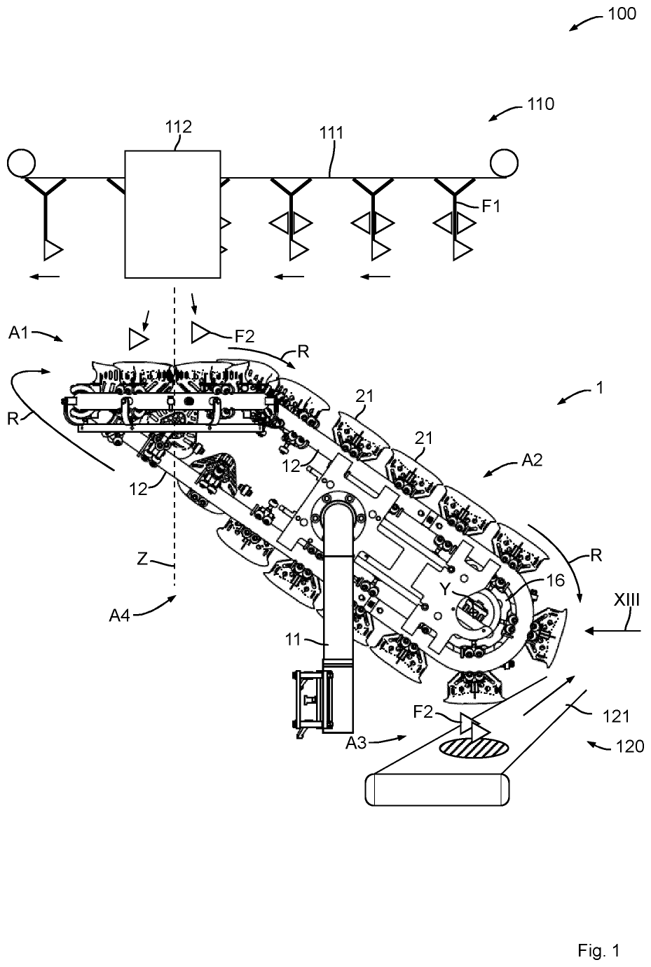

FIG. 1 shows a conveying arrangement 100 according to the invention. The conveying arrangement 100 comprises a feeding device 110, by which product parts F2 are provided. These product parts F2 are in particular poultry meat parts, such as chicken wings, chicken breasts or chicken legs.

The feeding device 110 comprises a feeding conveyor 111, which can be designed as an overhead conveyor. Larger product units F1 are conveyed to this feed conveyor. These product units F1 are in particular a poultry carcass.

The feeding device 110 comprises a delivery unit 112, which provides product parts F2 of the product unit F1. In particular, the delivery unit comprises a dismantling device which separates the product parts F2 from the product units F1.

The product parts are finally transported away by a discharge device 120. The discharge device 120 can have a discharge conveyor 121, in particular a conveyor belt.

A conveyor device 1 according to the invention is provided for transferring the product parts F2 from the feeding device 110 to the discharge device. The conveyor device 1 is adapted to take over the product parts F2 from the feed conveyor 111 at a takeover area A1 and to handover them to the discharge device 120 at a handover area A3.

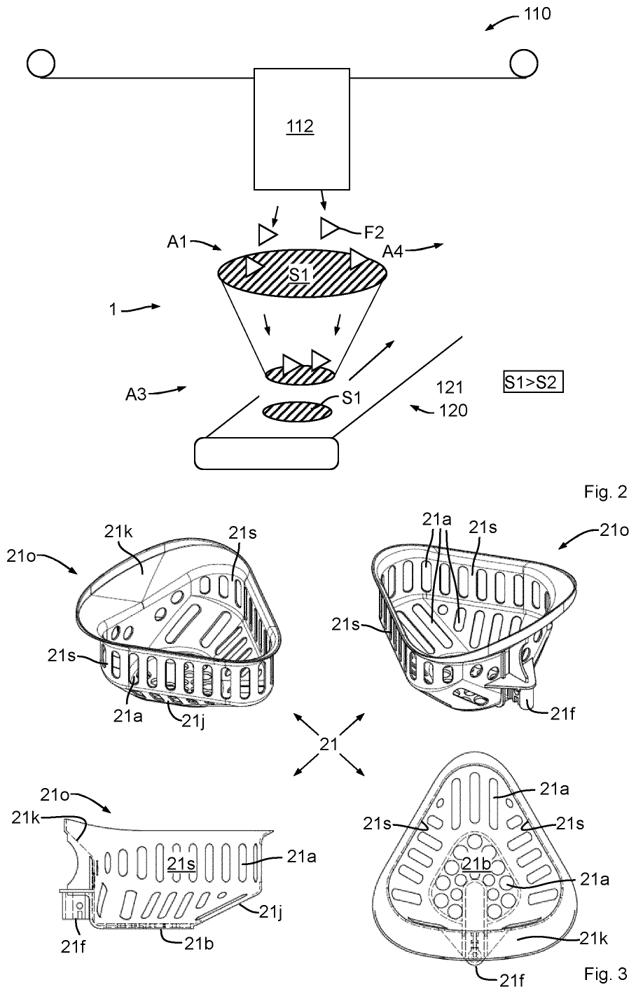

FIG. 2 shows in a reduced representation a function of the conveyor device 1 within the conveying arrangement 100. The provision of the product parts F2 at the takeover area A1 and the delivery of the product parts F2 at the handover area A3 are shown schematically. It can be seen that the takeover area A1, viewed in top view, has a first surface area S1 which is significantly larger than a second surface area S2, viewed in top view, of the handover area A3. This is due to the fact that the delivery unit 112 provides the product parts F2 in a large spatial dispersion.

Consequently, the conveyor device 1 fulfills a spatially funneling function in order to position the product parts F2 arriving at the takeover area A1 in a spatially widely scattered manner in a defined manner in a comparatively small handover area A3.

In conventional conveyor arrangements, this funneling function is performed by a suitably shaped stainless steel plate between the takeover area A1 and the handover area A3. The product parts F2 slide along the stainless steel plate. Each part leaves behind individual contaminations. After about one hour of operation, there are individual contaminations on the stainless steel sheet, for example from several thousand product units F1. Further product parts sliding along now come into contact with these contaminations.

The present invention now provides a way for the individual product parts to get significantly less contaminated with contaminants from other product parts. For this purpose, a conveyor device according to the invention is used instead of the stainless steel sheet, which is explained in more detail below.

The conveyor device 1 according to the invention (see FIG. 1) comprises a plurality of transport units 21. Such a transport unit 21 can, for example, be designed as a basket. Other forms are also possible, although it should be ensured that the transport unit 21 can safely pick up the product parts F2 and selectively deliver them again.

The transport units 21 are arranged to be transferable along a conveying direction R between the takeover area A1 and the handover area A3. At the takeover area A1, a transport unit 21 takes over one or more product parts F2 and transports them to the handover area A3, where the transported product parts F2 are handed over to the discharge device 120. Downstream of the takeover area A1 in the conveying direction R and upstream of the handover area A3 is a transfer area A2, which is essentially provided for bridging a distance between the takeover area A1 and the handover area A3. Upstream of the takeover area A1 in the conveying direction R and downstream of the handover area A3 is a return area A4, which is essentially provided for returning the transport units 21 from the handover area A3 to the takeover area A1. The conveying direction R is circulating, so that the transport units return to a starting position after one circulation.

The transport units (FIG. 3) comprise side walls 21s and a base 21b. The side walls 21s and the base 21b form a receiving space for receiving the product parts. The product parts can enter or leave the receiving space through a receiving opening 210.

The walls have a plurality of recesses 21a. The recesses 21a are arranged on the base 21b and the side walls 21s in such a way that the product parts are held reliably in the receiving space, but on the other hand the contact area between the product parts and the transport unit is as small as possible. The transmission paths of contamination are thus reduced to a minimum. The walls (base and side walls) form a downwardly pronounced taper 21j. This reduces the outer circumference of the transport unit downwards.

Above the first fastening section 21f, the side wall 21s has a collar 21k that covers the first fastening section 21f when viewed from above. The collar 21k is inclined downward in the direction of the receiving space. Falling product parts F2 are thus kept away from the first fastening section 21f and guided into the receiving space as conveyed goods F2.

In top view, the transport unit 21 has a triangular shape in particular. This will be discussed later.

The conveyor device 1 comprises a base support 11. A support rail 12 is attached to the base support 11. The support rail 11 defines the conveying direction R. The transport units 21 are movably arranged on the support rail 12. The support rail 12 can be composed of several individual support rail segments.

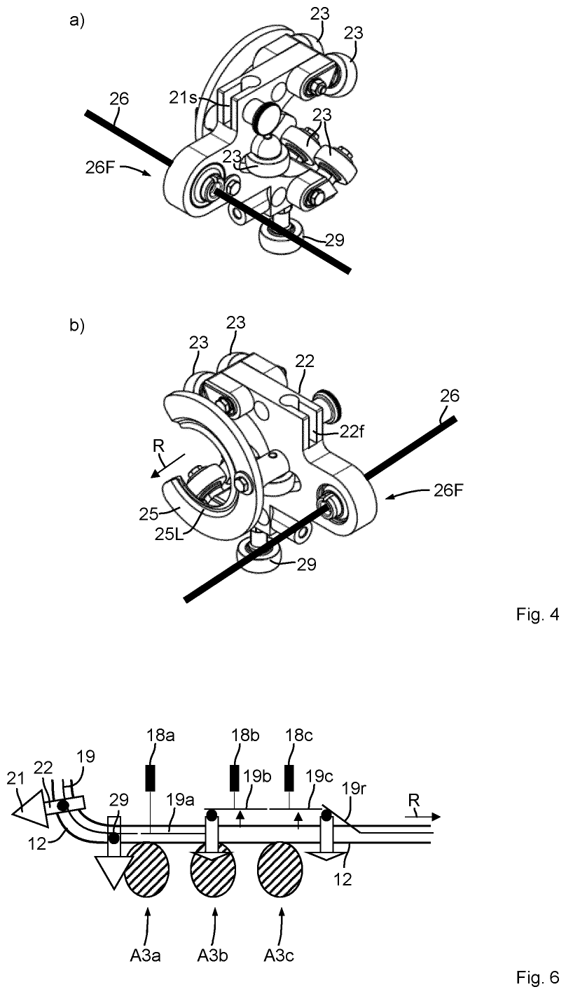

The transport units 21 are each attached as to a transport carriage 22 (FIGS. 3, 4). The transport carriage can travel along the support rail 12. Transport rollers 23 are attached to the transport carriage 21, which roll along the support rail 12. The transport rollers 23 are arranged on the transport carriage 22 in such a way that the transport carriage 22 can be moved along only one translational degree of freedom, namely the conveying direction R.

The support rail 12 has a circular cross-section. The transport rollers 23 are arranged circumferentially distributed around the circular cross-section of the support rail 12. The transport rollers 23 are arranged on the transport carriage 22 such that the transport carriage 22 is movable along a rotational degree of freedom. The rotational degree of freedom corresponds to the circumferential direction of the circular cross-section.

The transport carriage has a C-shaped configuration as viewed in the conveying direction R. This makes it possible for the transport carriage to grip around the circular at least in the circumferential direction by more than 180°, which is important for a stable mounting. Furthermore, the transport carriage can readily pass rail holders 13 which are connected to the support rail 12 at regular intervals and connect the support rails to the base support 11.

The transport carriage 21 has a second fastening section 22f to which the first fastening section 21f of the transport units 21 is connected. The two fastening sections are configured such that they define a defined orientation of the transport unit 21 relative to the transport carriage 22. Consequently, in conveying operation, the transport unit 21 is immovable relative to the transport carriage 22. This does not preclude the transport unit 21 can be detached from the transport carriage 22.

The transport carriage 22 is designed to pivot, which is made possible in particular by the above-mentioned rotational degree of freedom. By pivoting the transport carriage 22, the transport unit 21 is also pivoted (FIG. 5). In the pivoted state (handover position), the parts can be removed from the receiving space in a defined manner due to gravity.

The pivot position of the transport carriage 22 and/or the transport unit 21 is controlled by a control device. In the present case, the control device can be operated mechanically. The control device comprises a first control element, here for example in the form of a control rail 19, which acts together with a second control element 29 connected to the transport unit 21, here indirectly via the transport carriage 22. The position of the control rail 19 relative to the support rail 12 defines the pivoting of the transport container 21 and/or the transport carriage 22.

In one embodiment, the control rail 19 is stationary. This results in each transport unit being displaced from the receiving position to the handover position and vice versa at the same point based on its position along the transport direction. This is particularly useful if the conveyor device has exactly one handover area at which all product parts F2 are handed over.

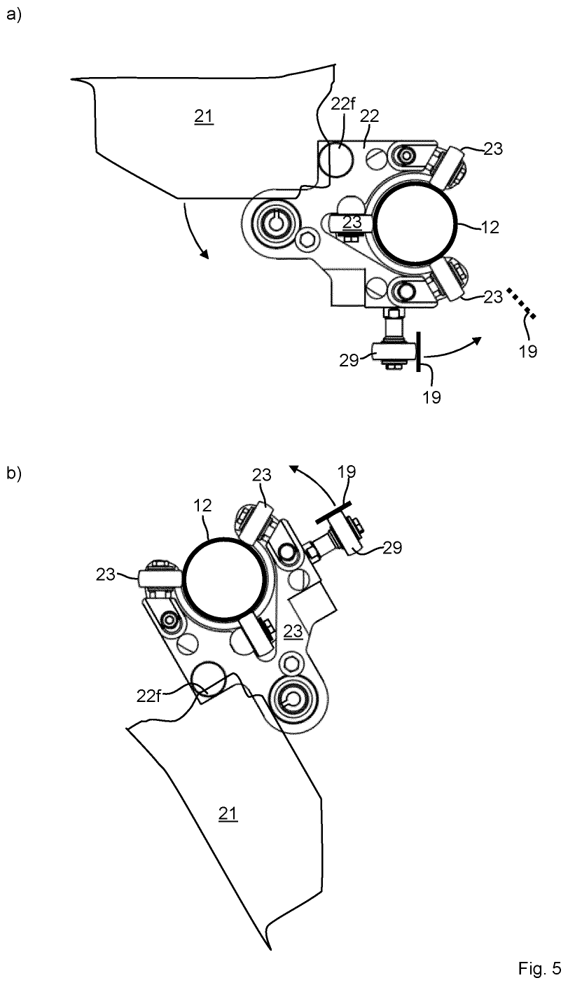

In one embodiment, the conveyor has several handover areas A3a, A3b, A3c. A section of such a conveyor is shown schematically in FIG. 6. The conveyor device can selectively handover the parts to one of the several handover areas.

In one embodiment, the control rail 19 has separately displaceable control rail segments 19a,b,c in sections for this purpose. The control rail segments 19a,b,c can each be assigned to a specific handover area. The control rail segment is thereby displaceable between a handover position and a receiving position. The displacement can take place by means of an actuator 18a-c, for example a pneumatic actuator. The actuator 18a-c can be assigned to one of the control rail segments 19a-c in each case.

In FIG. 6, control rail segments 19b, c are in the handover position and control rail segment 19a is in the receiving position. If the transport unit 21 and/or the transport carriage 22 passes a control rail segment 19a that is in the receiving position, the transport unit 21 remains in the receiving position. The product parts in the corresponding transport unit 21 are not handed over in the handover area A3a, which is assigned to this control rail segment 19a.

If the transport unit 21 and/or the transport carriage 22 passes a control rail segment 19b, c that is in the handover position, the transport unit 21 is displaced to the handover position. The product parts in the corresponding transport unit 21 are then handed over in the handover area A3b, to which this control rail segment is assigned in the handover position. In the subsequent handover area A3b, no more product parts are then handed over, since these have already been handed over in handover area A3b, even if the assigned control rail element 19c is in the handover position.

The displaceable control rail segments 19a,b,c can be followed by a return segment 19r so that the transport units 21 are all subsequently displaced to the receiving position.

The individual transport units 21 are drive-connected to each other via a traction means 26 (FIG. 4). The traction means 24 is in particular an elastic rope. This results in particular in a ropeway-like configuration in which the individual transport units are pulled one behind the other by the traction means.

The connection of the traction means 24 to the respective transport units 21 can be made in particular indirectly via the respective transport carriage 22.

At an attachment point 26F, the traction means 26 is drive-connected to the respective transport unit 21 and/or the respective transport carriage 22. The traction means can be fastened at the attachment point 26F, e.g. by clamping.

The traction means 24 may be driven by a motor, which is not shown, and a traction sheave connected thereto.

In particular, the transport units 21 are attached to the traction means 24 at evenly spaced intervals. The traction means 24 can comprise several individual sections, which are connected to one another, in particular on a transport unit 21 or the transport carriage 22, to form a traction means 24.

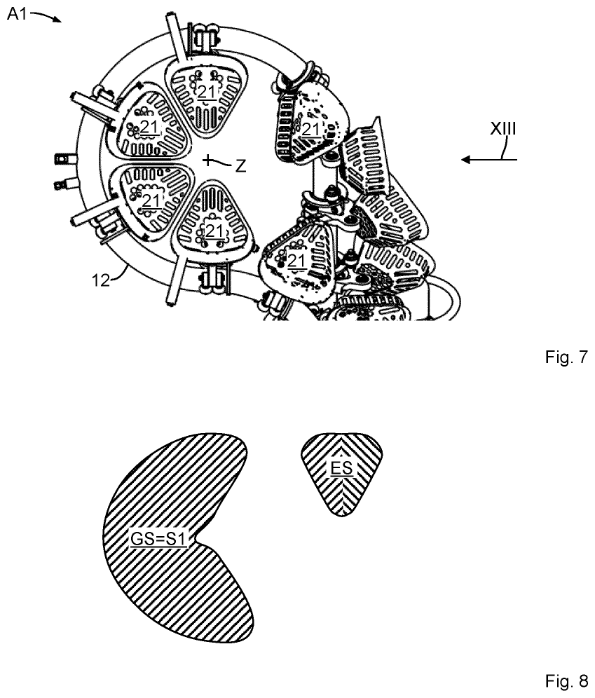

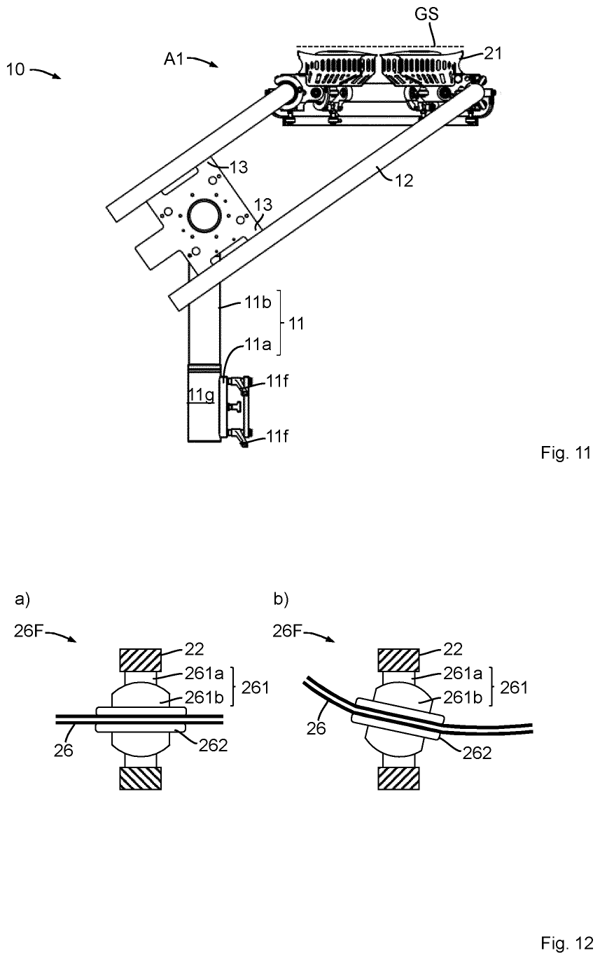

FIG. 7 shows the takeover area A1 in top view. It can be seen that a plurality, in this example four, of the transport units 21 are now positioned close to each other in such a way that they provide a common catching area for product parts. Together, these transport units 21 form a circular sector shape. Together, these transport units 21 form a total catching surface GS, which is the dashed area shown in FIG. 8. Those product parts F2 which hit this total catching surface GS are automatically caught by one of the transport units 21. Any gaps between the transport units are so small that the product parts intended in the intended use cannot fall through there. In FIG. 11, it can be seen that the plurality of transport units 21 are arranged next to each other in a common plane, thus forming the total catching surface GS (shown schematically above in dashed lines).

The total catching surface GS corresponds to at least twice, in particular three or four times, an individual catching surface ES of a single transport unit, which is shown next to the total catching surface GS in FIG. 8. The gaps between the individual transport units 21 are so small that no product parts F2 can fall through between the gaps. Rather, the gaps thus contribute to the total catching area such that the total catching surface GS is greater than the sum of the individual catching surfaces ES of the participating transport units 21. In this case, GS>n×ES, where n is the number of participating transport units 21. In the example according to FIG. 8, the n=4.

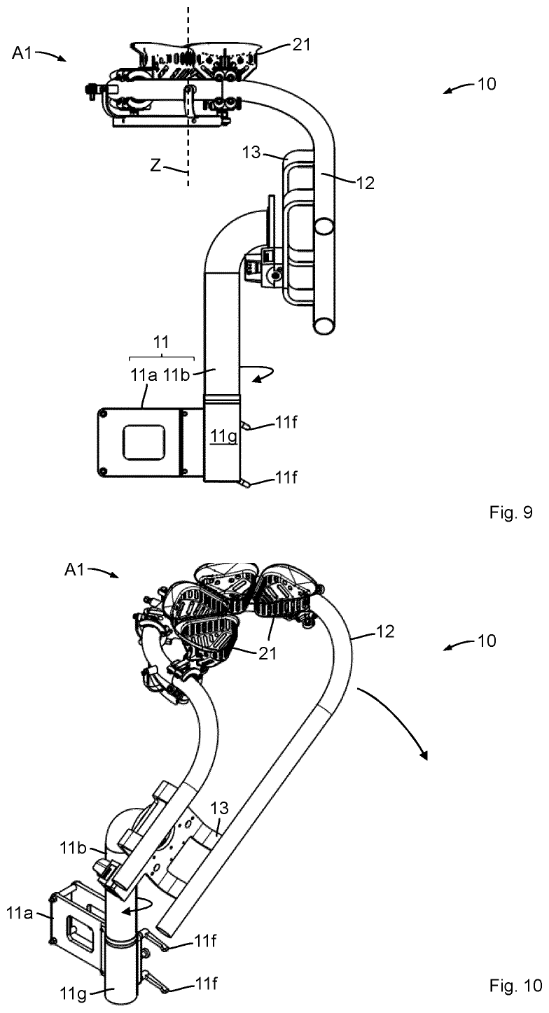

The support rail 11 is part of a holding arrangement 10 (FIGS. 9, 10). In the present example, the support arrangement 10 also includes the rail holder 13 and the base supports.

The base support is designed in two parts, for example. A first base support part 11a is immovable, in particular firmly connected to the substrate or a wall. A second base support part 11b is movable if required. The support rail 12 is fastened to the second base support part 11b, in particular indirectly via the rail holder 13.

The support rail can thus be displaced between an operating position and a maintenance position. In the operating position, the takeover of the product parts from the feed device 110 can take place in the takeover area. In the maintenance position, the support rail is removed from the area below the delivery unit 112 of the feed device. Now the delivery unit 112 can be cleaned from below.

In the present case, the second base support part 11b is designed to be rotatable relative to the first base support part 11a, with a swivel joint 11d being provided. Fixing means 11f, for example a locking screw, can be used to hold the alignment of the two base support parts 10a, 11b relative to one another.

A wiper 25 is provided between individual or all of the transport units 21, which moves along the support rail 12 between individual transport units 21. The wiper 25 is set up to mechanically remove impurities from the support rail 12. The wiper 25 may be attached to, and move with, one of the transport carriages 22 for guiding the transport units, respectively. In this case, the wiper is arranged in particular in front of the transport carriage 22 in the conveying direction.

Alternatively, a separate transport carriage is also conceivable, on which only the wiper is provided. The wiper can have a rubber lip 25L that is in sliding contact with the support rail 12.

FIG. 12 shows the rope fastening 26F in detail in cross-section. The rope fastening 26F has a rope receptacle 262, relative to which the rope 26 is connected in a tension-proof manner. The tension-proof connection can be ensured by a clamping screw.

The rope receptacle 262 is fixed relative to the transport carriage 262. The rope attachment 26F has a joint 261, which is arranged between the rope receptacle and the transport carriage. The joint 262 allows the direction of the rope receptacle 262 to be changed relative to the transport carriage 22.

In particular, the joint 261 is a ball and socket joint having a joint inner portion 261b and a joint outer portion 261a which slidably engage each other at a common ball portion surface.

Due to the curved course of the transport rail, there is a constant change in the alignment of adjacent transport carriages. The articulated rope support avoids stress peaks on the rope itself, which has a positive effect on the durability of the rope.

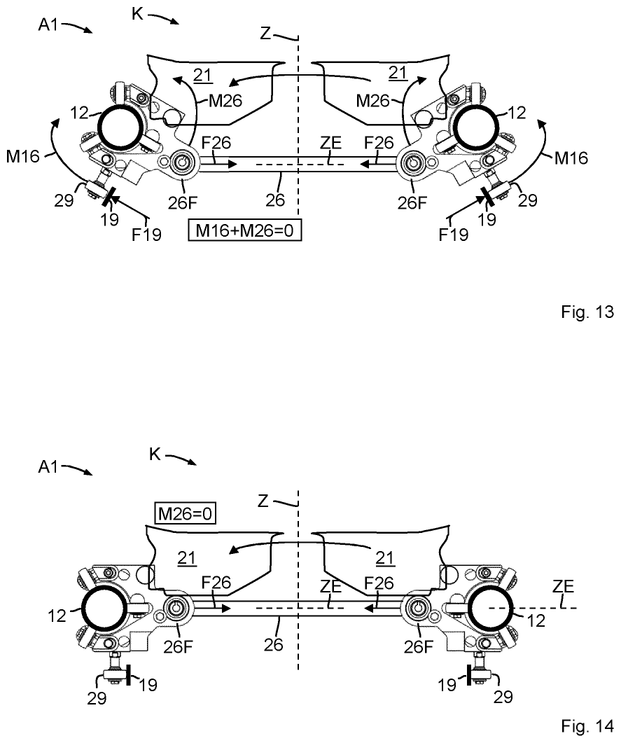

FIG. 13 shows the takeover area A1 in connection with transport units 21 arranged there. The description of the following problem definition serves as a representative for all curve areas of the conveyor device 1. In the figure, the transport units shown behind the picture plane are not shown for better comprehensibility of the figure.

As previously described, the transport units 21 are all connected to the traction means 26. In straight sections, the guidance of the traction means is comparatively unproblematic; in curved sections, the traction means can lead to tensions.

In the takeover area A1, the transport units 21 are guided along a 180° turn in a curved section K (FIG. 7). FIG. 13 shows a design of the takeover area. This means that the traction means not only transmits a traction force along the conveying direction but also a force F26 that leads in the direction of the center of the bend.

The force generates a swivel torque M26, which acts on the transport units 21 in an upward swiveling direction. However, the control elements 19, 29 ensure that the transport units 21 remain in the desired position. They now generate a counter-torque M16 counteracting the swivel torque M26. For this purpose, control forces F19 are provided by the control elements 19, 29.

The control forces F29 generate friction to the control elements, which in turn slow down the entire conveying process. In particularly unfavorable embodiments, the occurrence of the swiveling moments and the associated forces can lead to tensioning or jamming, which brings the entire conveyor device to a standstill.

FIG. 14 shows an alternative design. In the takeover area A1, the traction means 26 are arranged in a traction means plane ZE that lies in a common plane with the guide rail 12. The forces pointing to a center axis Z of the bend now no longer generate a swiveling moment M26. This means that the opposing support by the control elements 19, 29 can be dispensed with. The control elements 19 are now only provided to hold the transport units 21 in the correct orientation with comparatively low force application, without having to counteract significant swivel moments for this purpose. The resistance forces occurring at the control elements 1, 29 are thus significantly lower than in the design according to FIG. 13.

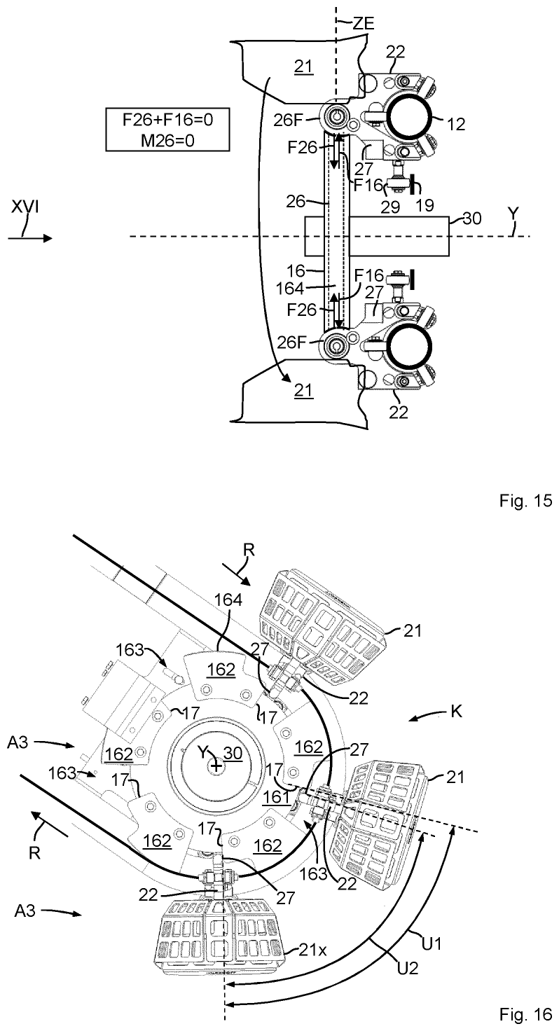

FIG. 15 shows an alternative possibility for avoiding resistance forces in the area of a curved section K of the conveyor device 1. This is implemented at the handover area A3 as an example. At the handover area A3, the transport units move around a horizontal axis Y in the curved section K (see supplementary FIG. 1). The traction means 26, which connect the transport units 10 to one another, are arranged in a traction means plane ZE that does not run through the support rail 12. In this respect, the traction means 26 generate, in principle, a rope force F26 which could act on the rope fastenings 26F toward the axis Y. A support wheel 16 is provided, which guides the traction means 26 in the area of the curve. The drive wheel 16 has a peripheral surface 164, possibly interrupted, against which the traction means 26 rests for radial support.

The forces F16 and F26 thus neutralize each other, so that the transport unit is not subjected to any swiveling moment M26 in the direction of axis Y, which would again have to be compensated by the control elements.

Alternatively or in combination, the support wheel 26 directly supports the transport unit 11 and/or the transport carriage 12 radially with a support force F16 and may be arranged parallel to the support means plane.

The support wheel 16 also represents a drive wheel and is drive-connected to a drive 30, for example a drum motor. The drive wheel 30 can be connected to the drum motor 30 by a material or force fit; in particular, the drive wheel is attached to a circumferential surface of the drum motor. A second drive surface 27 is provided, through which a driving force is transmitted non-positively from the drive wheel 30 to one of the transport units 21 and/or the transport carriages 22. The transmission of the driving force is not shown in FIG. 15. By connecting the transport units 21 and/or the transport carriages 22 to each other by the traction means 26, the drive force is also transmitted to the other transport units 21 and/or transport carriages 22.

FIG. 16 shows the drive wheel 16 in more detail. The drive wheel 16 is optionally designed in two parts here and has an inner wheel 161 and several circumferentially distributed wheel attachments 162.

The drive wheel 16 has a plurality of circumferentially distributed first drive surfaces 17, each of which cooperates with second drive surfaces 27 to transmit the driving force from the drive wheel 26 to the transport units 21 and/or the transport carriages 22. For this purpose, the drive wheel has radially outwardly engagement recesses 163 which is partially bounded by the first drive surface and is arranged in the second drive surface. The transport carriage or the transport unit must engage positively in the engagement recess 163. In the present case, the engagement recess 163 is formed in each case by an intermediate space between two circumferentially adjacent wheel attachments 162. For the sake of clarity, only some of the engagement recesses 163 in FIG. 16 are provided with reference lines.

The rope receptacle 261 is arranged radially on the outside of the drive wheel. It should be noted here that the traction means is preferably merely placed in the rope receptacle without any jamming occurring between the rope receptacle and the traction means. Even if the rope receptable is named in this manner, this does not implicitly mean that the traction means is necessarily a rope.

Optionally, the drive surfaces 27 and/or the rope receptacle 261 are provided on the wheel attachments.

FIG. 16 shows that only the transport unit 21x or its transport carriage 22 is in drive connection with the drive wheel 16, since the associated drive surfaces 17, 27 are in contact with each other. The respective second drive surface 27 of the other transport units 21 (reference signs 21 without x) are not in contact with the respective nearest first drive surface 17 on the drive wheel 16. In this case, the drive surfaces 17, 27 are kept at a distance from one another. This is achieved by the first circumferential distance U1 of two first drive surfaces 17 being greater than the second circumferential distance U2 of the successive following transport units 21 or transport carriages 22, this distance being to be understood in the angular dimension about the common axis of rotation Y.

This ensures that only that transport unit 21x is in drive connection with the drive wheel which, viewed in the conveying direction R, assumes the foremost position of all transport units 21 located at the drive wheel 16. This in turn ensures that reliable threading of the transport carriages or transport units into engagement recesses 163 of the drive wheel 16 is guaranteed, even if the traction means, which is preferably of elastic design, are subject to a certain linear expansion. Such linear expansion may occur due to wear or may be caused by unexpected high resistance in the conveyor device. In the present example, the drive connection is preferably positive-locking, since this allows a predetermined cycle to be maintained.

Strictly speaking, FIG. 16 shows a direct drive connection between the drive wheel 16 and the transport carriage 22, since the second drive surface 27 is arranged on the transport carriage. Since the transport carriage 22 is firmly connected to the associated transport unit 21, this describes a drive connection between the drive wheel and the transport unit. The structural separation between the transport carriage and the transport unit is irrelevant here. It is therefore also possible for the second drive surface to be directly connected to the transport unit or to another element which also circulates with the transport unit in the conveying direction R.

In particular, the transport carriage can be regarded as a component of the transport unit, especially with regard to the drive connection between the drive wheel and the transport unit. Other parts that rotate firmly with the transport unit can also be regarded as its components.

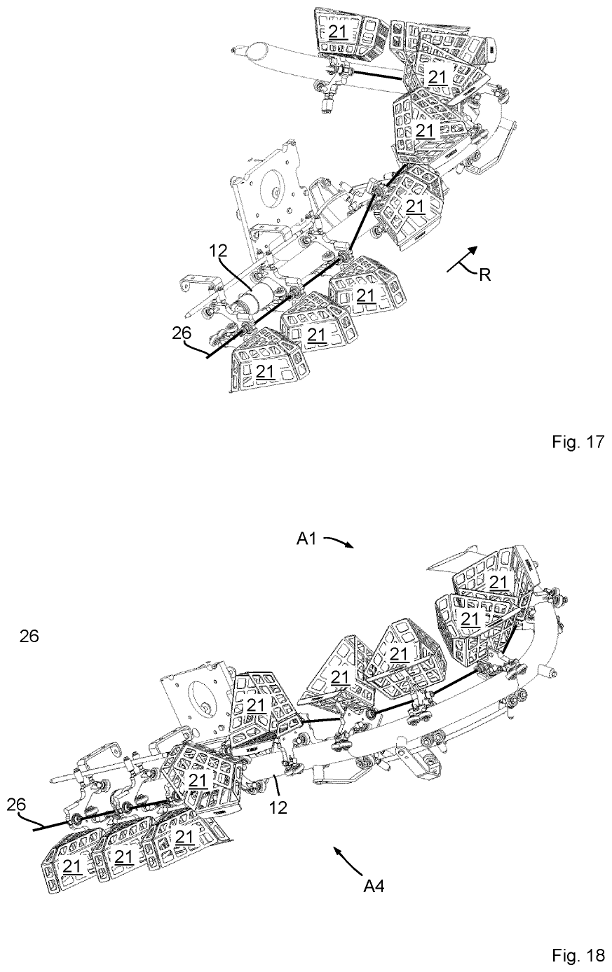

FIGS. 17 and 18 are described together. The transport units 21 leave the handover area A1 in their handover position and enter the return area A4 in this position. At the takeover area A1, the transport units are in their receiving position.

In the return area A4, the transport units 21 are therefore pivoted from their handover position to the receiving position. For this purpose, the transport units 21 follow a spiral path of movement.

In the spiral section of the conveying direction R, there is a change in the circumferential position of the transport unit 21 on the support rail 12, while at the same time there is an axial displacement of the transport unit 21 along the support rail 12.

As explained with reference to FIGS. 13 to 17, a defined alignment between curves in the conveying direction R or support rail 12 and the traction means 26 is an important prerequisite for the low-tension and thus low-friction operation of the conveyor device 1. This defined alignment can be realized in the present case by providing the spiral movement path in a straight section of the support rail 12. When entering the curve at the takeover area A1, the spiral movement is already completed and the defined alignment according to FIG. 14 is established.

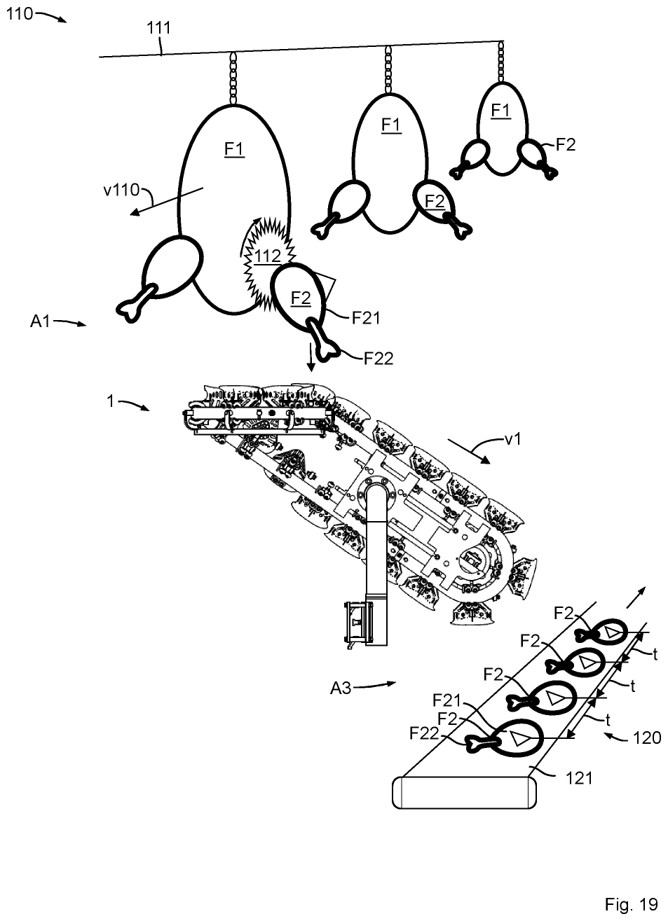

FIG. 19 schematically shows an embodiment of the conveyor arrangement 1 according to FIG. 1 with a feeding device 110, a conveyor device 1 and a discharge device 120. The feeding device has a dismantling device 112 as a delivery unit, shown here by way of example as a cutting knife. All of the features described above are also applicable to this embodiment, provided that they do not contradict it.

The conveyor device 1 places the product parts F2 in a predefined orientation on the discharge device.

Depositing takes place in a predefined cycle. A conveying speed V1 of the conveyor device 1 is matched to the conveying speed of the feeding device. This means that a product part always reaches a predetermined transport unit. In this way, the product parts are delivered to the discharge device in a predetermined cycle.

As the discharge device now has a discharge conveyor 121, the object parts (assuming a constant removal speed) can be deposited at a predefined cycle distance t from each other, which is expressed as a local distance t between two subsequent object parts. Furthermore, the object parts are all delivered to the discharge device 120 in a predefined orientation. The defined orientation is shown schematically, for example, by a triangle, which represents, for example, a position of the object part that should be at the top of the discharge device within the predefined orientation.

In the present example, the object part F2 is a chicken leg whose thigh bone F22 (exemplary for a second object part) points in a predefined direction from the upper leg F21 (exemplary for a first object part) at the discharge device 120 within the predefined orientation.

As already indicated at the beginning, however, this is not possible without further ado, since the object parts F2 are initially dispensed by the feeding device 110 in a wide distribution with regard to the dispensing location and dispensing orientation without further precautions. The wide distribution can also lead to the object parts hitting the transport units at different positions. Depending on the point of impact on the transport units in the takeover area according to FIG. 7, this can lead to one object part overtaking another object part and then arriving at the handover location more quickly. The sequence of the object parts arriving at the discharge arrangement therefore does not necessarily correspond to the original sequence of the object units F1 at the feeding device.

The object parts F2 are not provided with any means of identification. It is therefore not possible to identify an isolated object part at the discharge device according to its origin, e.g. to assign it to a specific object unit F1 from which the object part F2 originates. Traceability can now be established by the conveyor arrangement 100 or the conveyor device in that the object parts F2 are reliably transferred by the conveyor device 1 to the discharge device 120 in the same sequence in which object parts F2 are fed to the feeding device 110. From the sequence, assignments between the object parts and data stored in a database can thus be created or used.

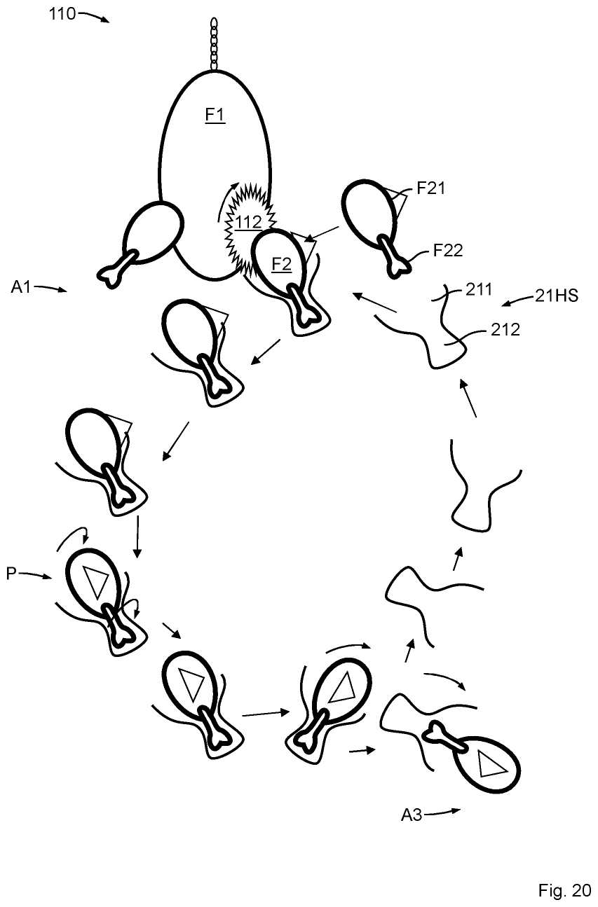

In the following, it is explained by way of example with reference to FIGS. 20 to 24 how the object parts F2 can be discharged at the discharge device 120 by the conveyor device 1 in such a way that the object parts F2 are discharged at the discharge device 120 in a defined orientation, in a defined cycle and in the original sequence. Unless contradictory, the disclosure of the following figures is applicable to the above disclosure of the conveyor device of FIGS. 1 to 18.

FIGS. 20 to 22 each show an embodiment of in which the transport unit is adapted as defined to the object part to be transported.

The transport unit 21 is exemplarily defined as a chicken leg transport unit. The chicken leg transport unit 21HS comprises a plurality of receiving areas 211, 212. A first receiving area 211 is designed to receive the first object part F21, here exemplified as an upper leg receiving area for an upper leg F21 of the object part F2. A second receiving area 212 is designed to receive the second part of the object part F22, here exemplarily as a thigh bone receiving area for a thigh bone F22 of the object part F2 protruding from the upper leg.

At the takeover area A1, the transport unit 21 is positioned relative to the object part F2 in such a way that the object part F2 is taken over by the transport unit 21 in a defined orientation.

In a first embodiment, this can be achieved as shown in FIG. 20. In this case, the transport unit 21 already interacts with the object part F2 to be received during the dismantling process in such a way that the object part F2 projects at least partially into a receiving area 211 of the transport unit 21. During the dismantling process, the transport unit 21 is moved synchronously with the object part. FIG. 20 shows the object part protruding almost completely into the transport unit 21, but this is not necessary. It may be sufficient if, for example, only the second part of the article F22, in particular the leg bone, partially protrudes into the first receiving area 211. In particular, self-alignment now takes place as a result, whereby any inaccuracies in the alignment of the delivered object part are compensated for by the shape of the transport unit.

The object part can be aligned, for example, by turning the transport unit, as shown schematically for the transport unit marked with the arrow P. The alignment can of course also be changed by tilting it to the bottom right.

FIG. 21 shows a second embodiment that is widely based on the first embodiment. In this respect, only the differences are discussed. Here, the transport unit 21 is arranged below the object part F2 during the dismantling process and is moved synchronously with the object part F2 during the dismantling process. In particular, it can be utilized if the specific object part F2 is delivered from the delivery device with comparatively little local dispersion. In the present case, the object part falls downwards towards the transport unit 21. Due to the embodiment described above, for example, the transport unit is able to catch the object part in the desired orientation and to compensate for any deviations from the desired orientation.

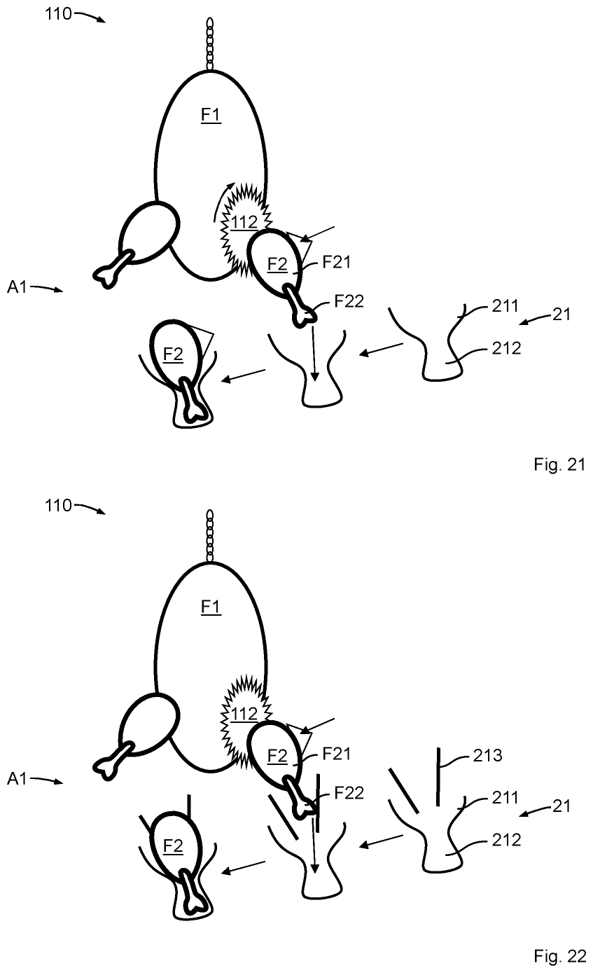

FIG. 22 shows a third embodiment based on the second and/or first embodiment. In this respect, only the differences are discussed. The receiving of the object part by the transport unit 21 is supported by a guiding device 213. This guiding device 213 may in particular comprise a guide plate or a guide rail. Inaccuracies in the delivery of the object parts can be compensated for by the guiding device.

In one embodiment, the guiding device can be arranged in a fixed position, in particular in a fixed position on the feeding device or on the conveyor device.

In one embodiment, the guiding device can be a component of the transport unit 21. As such a component, the guiding device 213 travels with the transport unit 21 and can also travel with it through a cleaning device (see as yet unpublished DE 10 2021 109 698.7), if such a device is present. With such a traveling guiding device, increased hygiene can be achieved compared to the stationary chute as described above.

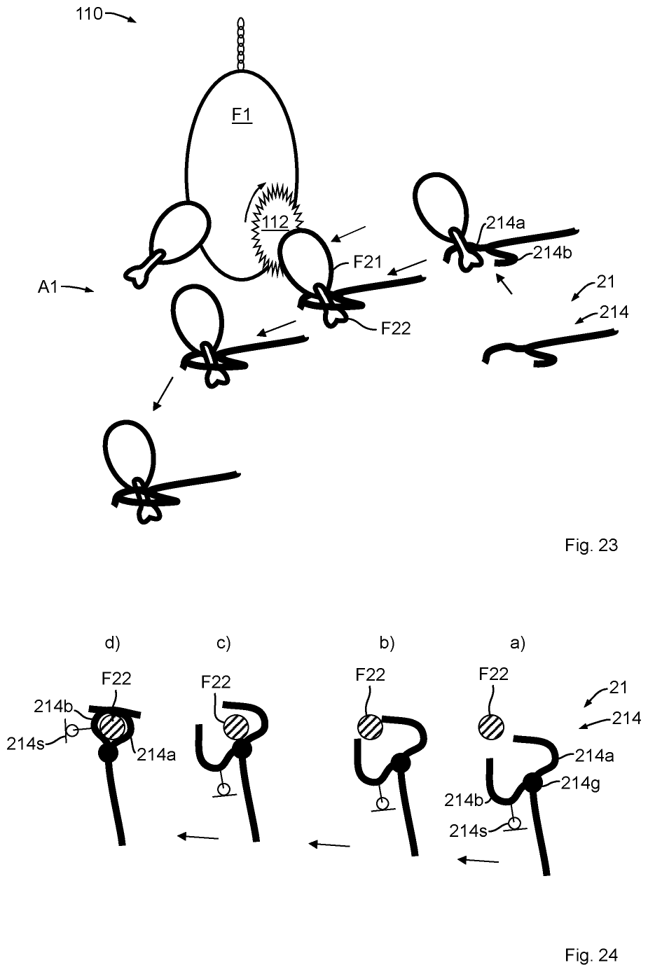

FIG. 23 shows a fourth embodiment. Here, the transport unit 21 comprises a gripper 214 in each case, whereby the gripper 214 can thereby form the transport unit 21. FIGS. 24a-d show an isolated gripper in different gripping states in conjunction with a product sub-part, here in the form of a leg bone. Suitable grippers are also described, for example, in WO 2014/140375 A2.

The gripper 214 comprises two gripper parts 214a, 214b, which are held movably relative to each other, for example by means of a gripper joint 214g. The gripper can be moved between a release state and a gripping state. For this purpose, the gripper parts 214a, 214b can be movable relative to each other.

The gripper can grip an object part F2, in particular an object sub-part F22 of the object part F2, in the gripping state and thus hold it firmly. The transition from the release state to the gripping state is referred to as the gripping point in time.

FIGS. 24a-c show the gripper viewed from above in the release state. In FIG. 24a, the gripper moves relatively towards the object part F2. In FIG. 24b, a product sub-part F22 is partially enclosed by the gripper. In FIG. 24c, the gripper encloses the product sub-part F22. In FIG. 24d, the gripper is in the gripping state and is gripping the product sub-part F22. In the gripping state, the object part F2 is taken over at the takeover area A1 and conveyed to the handover area A3.

Once the gripper arrives at the handover area A3, it is transferred to the release state, whereby the object part F2 is transferred to the discharge device.

In the present embodiment, it is provided that the gripper 214 then grips the object part F2 as long as this is still held on the feeding device. In the present case, the object part F22 is still attached to the object unit F1 at the gripping point in time. For example, when the object part is separated from the object unit F1 by the dismantling device 112, the object part F2 is also released from the feeding device 110.

By gripping, the orientation of the object part F2 relative to the gripper 214 can be fixed. By amending the orientation of the gripper 214, the orientation of the object part F2 can be amended.

In one embodiment, a gripper control 214s is provided, which is set up to transfer the gripper between the release state and the gripping state. The gripper control 214s can be designed similarly to the control of the pivoting of the transport units (see FIG. 5). For example, a control rail can be provided whose relative position to the gripper defines the state. A control roller, which is connected to one of the gripper parts, can roll along the control rail.

All of the transport units from the embodiments according to FIGS. 19 to 24 can be arranged on a transport carriage 22 and move with it along the support rail 12. A change in the orientation of the alignment of the transport units can be made in accordance with the disclosure in FIGS. 5 and 6 above.

In all embodiments of FIGS. 19 to 24, it is intended that the object parts are already held in a defined orientation in the conveyor device. The object parts can then be transferred from the conveyor device to the discharge device in a defined orientation.

Placing the object parts at the predetermined distance t, in the correct sequence and in a defined orientation has the following advantages.

Due to the defined alignment and the defined distance/reliable separation, the subsequent processing steps allow a significantly increased degree of automation with reduced effort. Subsequent processing machines can be designed specifically for the respective alignment and do not have to be made robust against undefined alignments or overlaps. The personnel previously required to change the alignment of the object parts can be dispensed with.

Ensuring the defined sequence makes it possible to assign the object parts to a data record without the object parts having to be provided with an identifier, for example, or subsequently identified or classified on the basis of recognizable procurement or other detectable characteristics. The assignment is simply based on the position of the object part in the sequence of the object parts. For example, data that has already been assigned to the object unit (e.g. quality level, size class, damage, etc.) can be assigned directly to a separated object part F2. Subsequent processing steps can thus be controlled accordingly. If, for example, the quality level of the object units F1 is basically known, subsequent sorting of the object parts F2 according to quality levels can use this data accordingly. The embodiment shown in FIG. 6 can be used for sorting using the conveyor device.

LIST OF REFERENCE NUMERALS

| | |
|---|---|
| 100 | conveyor arrangement |
| 1 | conveyor device |
| A1 | takeover area |
| A2 | transfer area |
| A3 | handover area |
| A4 | return area |
| F1 | goods unit |
| F2 | conveyed goods/product parts |
| 10 | support arrangement |
| 11 | base support |
| 11a | first base support part |
| 11b | second base support part |
| 11g | joint |
| 12 | support rail |
| 13 | rail holder |
| 16 | support wheel/drive wheel |
| 161 | inner wheel |
| 162 | wheel attachment |
| 163 | engagement recess |
| 164 | peripheral surface |
| 17 | first drive surface on drive wheel |
| 18 | actuator |
| 19 | first control element (control rail) |
| 19a, b, c | control rail segment |
| 19r | return segment |
| 20 | transfer arrangement |
| 21 | transport unit (basket) |
| 21b | bottom wall |
| 21s | side wall |
| 21j | taper |
| 21f | fastening section on the transport unit |
| 21a | recesses |
| 21o | receiving opening |
| 21k | collar |
| 211 | first receiving area |
| 212 | second receiving area |
| 213 | guiding device |
| 214 | gripper |
| 214a, b | gripper part |
| 214g | gripper joint |
| 214s | gripper control |
| 22 | transport carriage (C-shaped) |
| 22f | fastening section on transport carriage |
| 23 | transport roller |
| 24 | coupling (of slides with each other) |
| 25 | wiper |
| 25L | rubber lip |
| 26 | traction means |
| 26F | traction means attachment point |
| 261 | joint |
| 261a | joint outer portion |
| 261b | joint inner portion |
| 262 | rope receptacle |
| 27 | second drive surface on transport carriage |
| 29 | second control element (control roller in engagement with |
| 30 | drive/drum motor |
| 110 | feeding device |
| 111 | feeding conveyor |
| 112 | delivery unit (cutter)/dismantling device |
| 120 | discharge device |
| 121 | discharging conveyor |
| R | conveying direction |
| GS | total catching surface |
| Es | individual catching surface |
| Z | vertical axis |
| Y | horizontal axis |
| F19 | control force by control elements |
| F26 | rope force |
| M19 | control element-conditioned counter torque |
| M26 | rope-conditional swivel moment |
| K | curve section |
| v1 | conveying speed of the conveyor device |
| v110 | conveying speed of the feeding device |
| t | cycle distance |
| ZE | traction means plane |
| U1 | first circumferential distance |
| U2 | second circumferential distance |
| F1 | product unit |
| F2 | product part |
| F21 | first product sub-part |
| F22 | second product sub-part |

1. Conveyor device (1), adapted
to take over a conveyed good (F2), in particular a piece of meat, at a takeover area (A1) from an upstream feeding device (110),
to handover the conveyed good (F2) at a handover area (A3), in particular to a downstream discharge device (120),
to transfer the conveyed good (F2) in a transfer area (A2) from the takeover area (A1) to the handover area (A3),
wherein the conveyor device (1) comprises a plurality of discrete transport units (21), in particular transport baskets (21),
the transport units (21) being arranged in particular in a circulating manner, characterized in
that the transport units (21) are adapted
to take over the conveyed good (F2) at the takeover area (A1),
to be transferred between the takeover area (A1) and the handover area (A3),
and to handover the conveyed good (F2) at the handover area (A3).

2. Conveyor device according to claim 1,
characterized in
that the transport units (21) are adapted to take over the conveyed good (F2) at the takeover area in a predefined orientation
and to handover the conveyed good (F2) at the handover area (A3) in a predefined orientation.

3. Conveyor device according to claim 1,
characterized in
that the transport units (21) have at least one first receiving area (211) which is designed to be complementary to a first product sub-part (F21) of the conveyed good (F2) which is to be conveyed by the conveyor device;
in particular further comprising at least a second receiving area (211) which is complementary to a second product sub-part (F22) of the conveyed good (F2).

4. Conveyor device (1) according to claim 1,
characterized in
that the transport units (21) comprise a gripper (214) which is adapted to grip the conveyed good (2) in a predefined orientation.

5. Conveyor device (1) according to claim 1,
characterized in
that the conveyor device (1) comprises a plurality of handover areas (A3a,b,c),
the control arrangement (19, 29) being adapted
to selectively displace the transport unit (21) between the receiving position and the handover position so that the conveyed good is selectively handed over at a selected handover area (A3b) selected from the plurality of handover areas (A3a,b,c).

6. Conveyor arrangement (100), comprising
a feeding device (110) for providing conveyed good (F2) at the takeover area (A3),
a conveyor device (1) according to claim 1 for transferring the conveyed good (F2) provided at the takeover area (A1) from the feeding device (110) to the handover area (A3),
in particular a discharge device (110) for discharging the conveyed good (F2) from the handover area (A3).

7. Conveyor arrangement (100) according to claim 6,
characterized in
in that the conveyor arrangement is adapted
to handover the conveyed good (F2) in a predefined orientation at the handover area (A3), in particular to the discharge device (120), and/or
to handover the conveyed good (F2) in a predetermined sequence at the handover area (A3), in particular to the discharge device (120), and/or
to handover the conveyed good (F2) in a predetermined cycle (t) at the handover area (A3), in particular to the discharge device (120), in particular furthermore in such a manner that the conveyed good (F2) is transferred separated in each case at the handover area (A3);
in particular in such a manner that three consecutively transferred conveyed goods have an identical orientation at the handover area (A3) and/or at the discharge device (120) and/or a distance between the conveyed goods (F2) is identical.

8. Conveyor arrangement (100) according to claim 6,
characterized in
that a dismantling device, in particular a meat dismantling device (112), is arranged at the takeover area (A1),
in particular the meat dismantling device (112) is set up to separate meat parts, in particular poultry parts, from a meat carcass, in particular poultry carcass (F1), and to make them available at the takeover area (A1) as conveyed good (F2).

9. Conveyor arrangement (100) according to claim 8,
characterized in that
a predetermined transport unit (21) is positioned in the takeover area (A1) relative to the dismantling device (112) in such a manner,
that a conveyed good delivered by the dismantling device is taken over by the predetermined transport unit.

10. Conveyor arrangement (100) according to claim 8,
characterized in
that one or the predetermined transport unit (21) is positioned in the takeover area (A1) in such a manner relative to the dismantling device (112),
that the conveyed good (F2) is already at least partially gripped by the transport unit (21) before and/or during the dismantling process, in particular is picked up or gripped,
and that the conveyed good thus gripped is transported by the transport unit (21) to the handover area (A3) after the dismantling process.

11. Conveyor arrangement (100) according to claim 8,
characterized in
that the predetermined transport unit (21) is positioned in the takeover area (A1) in such a manner relative to the dismantling device (112),
that the conveyed good (F2) is caught directly by the transport unit (21) after the dismantling process,
and that the caught conveyed good is transported by the transport unit (21) to the handover area (A3) after the dismantling process.

12. Conveyor arrangement (100) according to claim 11,
characterized in
that the conveyed good (F2) separated by the dismantling device, in particular falling down due to the dismantling process, is caught by the transport unit (21).

13. Conveyor arrangement (100) according to claim 8,
characterized in
that the transport unit is adapted to the conveyed good to be conveyed in such a manner that the conveyed good (F2) dismantled by the dismantling device, in particular falling down due to the dismantling process, is caught by the transport unit (21) in a self-aligning manner.

14. Use of a conveyor device according to claim 1 or a conveyor device in a conveying arrangement (100) according to claim 6 for taking over conveyed goods (F2) in the form of food parts, in particular meat parts, at the takeover area (A1) and for handover the conveyed good (F2) at the handover area (A3), in particular to a discharge device (120).

15. Use according to claim 14, for taking over the conveyed good (F2) immediately after a dismantling device (112),
wherein the conveyed goods (2) released by the dismantling device (112) are taken over by the transport units in a predefined orientation and the conveyed goods are discharged at the handover area in a predefined orientation.

16. Use according to claim 14, for taking over the conveyed good (F2) immediately after a dismantling device (112), wherein it is ensured that the conveyed goods (2) delivered by the dismantling device (112) are delivered by the transport units to the handover area (A3) in a sequence which corresponds to the sequence of arrival of the conveyed goods at the dismantling device (112).

17. Use according to claim 14,
for taking over the conveyed goods (F2) immediately after a dismantling device (112),
wherein it is ensured that the conveyed goods are transferred at the handover area (A3) in a predetermined cycle (t).
